(19) United States
(12) Patent Application Publication
(10) Pub. No.: US 2008/0084625 A1
(43) Pub. Date: Apr. 10, 2008

(54) Scanning module

(75) Inventors: Hsien-Chi Lin, Taichung (TW); Heng-Hsiang Chang, Taichung (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Asia Optical Co., Inc., Taichung (TW)

(21) Appl. No.: 11/903,372

(22) Filed: Sep. 21, 2007

(30) Foreign Application Priority Data
Oct. 4, 2006 (TW) 095136894

(51) Int. Cl. G02B 5/08

(52) U.S. Cl. 359/861

(57) ABSTRACT

A scanning module includes a body, a reflecting unit, and an image capture unit. The body includes a reflecting chamber disposed in a surrounding wall. The surrounding wall is formed with an incident hole allowing an incident light field to be transmitted into the reflecting chamber therethrough along an incident axis. The reflecting unit is disposed within the reflecting chamber, and includes a first reflector for reflecting the incident light field, as well as second and third reflectors for reflecting light transmitted from the first reflector to the image capture unit. An angle formed between the incident axis and a normal line of the first reflector is not smaller than 30 degrees. The image capture unit is disposed nearer to the incident hole than the first reflector along a direction of the incident axis, and includes a lens, and a sensing member.

### CROSS-REFERENCE TO RELATED APPLICATION

This application claims priority of Taiwanese Application No. 095136894, filed on Oct. 4, 2006.

### BACKGROUND OF THE INVENTION

1. Field of the Invention

This invention relates to a scanning apparatus, and more particularly to a scanning module for scanning documents.

2. Description of the Related Art

Referring to FIG. 1, a conventional scanning module includes a body 11, as well as a light-reflecting unit 12 and an image capture unit 13 that are disposed within the body 11. The body 11 includes a reflecting chamber 111, and an incident hole 113 formed throught a top wall 112. Light is emitted from a light-emitting unit 114 onto a document to be scanned, and is reflected into the reflecting chamber 111 through the incident hole 113 along an incident axis 125 so as to form an incident light field 116.

The reflecting unit 12 is disposed in the reflecing chamber 111, and includes a first reflecting mirror 121, a second reflecting mirror 122 for reflecting light transmitted from the first reflecting mirror 121, and a third reflecting mirror 123 disposed between the first and second reflecting mirrors 121, 122 for reflecting light transmitted from the second reflecting mirror 122. A preset angle θ formed between the incident axis 125 and a normal line 124 of the first reflecting mirror 121 ranges from 6 degrees to 8 degrees. The second reflecting mirror 122 is adjacent to the top wall 112, and is parallel to the first reflecting mirror 121. The image capture unit 13 includes a lens 131 and a sensor 132. Light reflected from the third reflecting mirror 123 passes through the lens 131, and is focused on and converted by the sensor 132 into a corresponding electrical signal. The sensor 132 may be a charge coupled device (CCD) image sensor or a complimentary oxide semiconductor (CMOS) image sensor.

Referring to FIG. 2, the incident light field 116 includes at least one accurate incident light beam 116′ forming the preset angle θ with respect to the normal line 124, and at least one inaccurate incident light beam 116″ forming an angle different from the preset angle θ with respect to the normal line 124.

The accurate incident light beam 116′ passes accurately through the lens 131 to thereby form a primary scanning image. However, after the inaccurate incident light beam 116″ is incident on the first reflector 121, it may reflect between the document to be scanned and the first reflector 121 a plurality of times prior to reaching the the second reflector 122. As a result, the image resulting from the inaccurate incident light beam 116″ and formed on the sensor 132 cannot match that resulting from the accurate incident light beam 116′, thereby affecting adversely the image forming quality and, thus, the scanning quality of the scanning module.

### SUMMARY OF THE INVENTION

The object of this invention is to provide a scanning module that has an improved scanning quality.

According to this invention, a scanning module includes a body, a reflecting unit, and an image capture unit. The body includes a reflecting chamber disposed in a surrounding wall. The surrounding wall is formed with an incident hole allowing an incident light field to be transmitted into the reflecting chamber therethrough along an incident axis. The reflecting unit is disposed within the reflecting chamber, and includes a first reflector for reflecting the incident light field, as well as second and third reflectors for reflecting light transmitted from the first reflector to the image capture unit. An angle formed between the incident axis and a normal line of the first reflecor is not smaller that 30 degrees. The image capture unit is disposed nearer to the incident hole than the first reflector along a direction of the incident axis, and includes a lens, and a sensing member.

Since the angle formed between the incident axis and a normal line fo the first reflector is not smaller than 30 degrees, light beams reflected from the first reflector are generally horizontal. That is, light reflected from the first reflector cannot be transmitted back onto a document to be scanned. As such, the scanning quality of the scanning module is improved.

### BRIEF DESCRIPTION OF THE DRAWINGS

These and other features and advantages of this invention will become apparent in the following detailed description of two preferred embodiments of this invention, with reference to the accompanying drawings, in which:

FIG. 1 is a schematic view of a conventional scanning module, illustrating the light path of an incident light field;

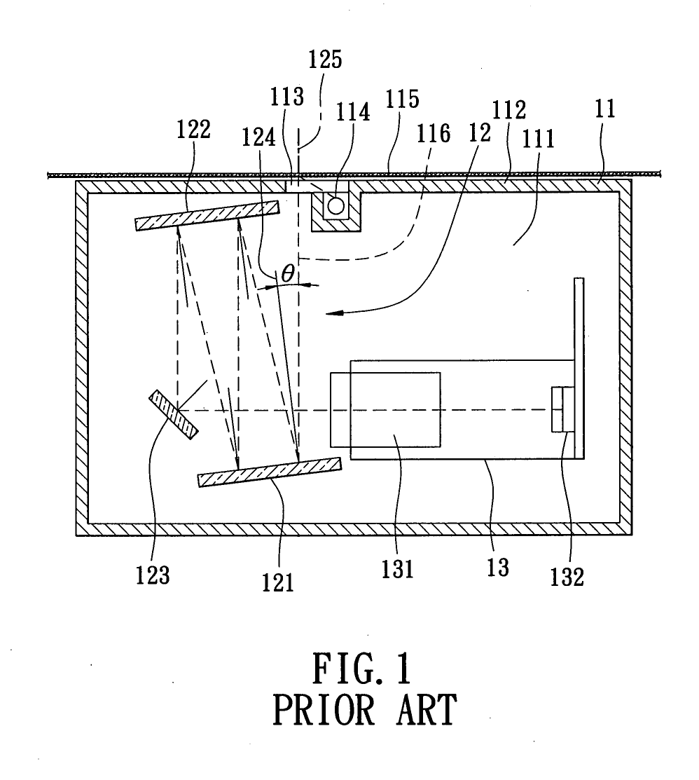

FIG. 2 is a view similar to FIG. 1, illustrating the light paths of an accurate and inaccurate incident light beams within the light field in the conventional scanning module;

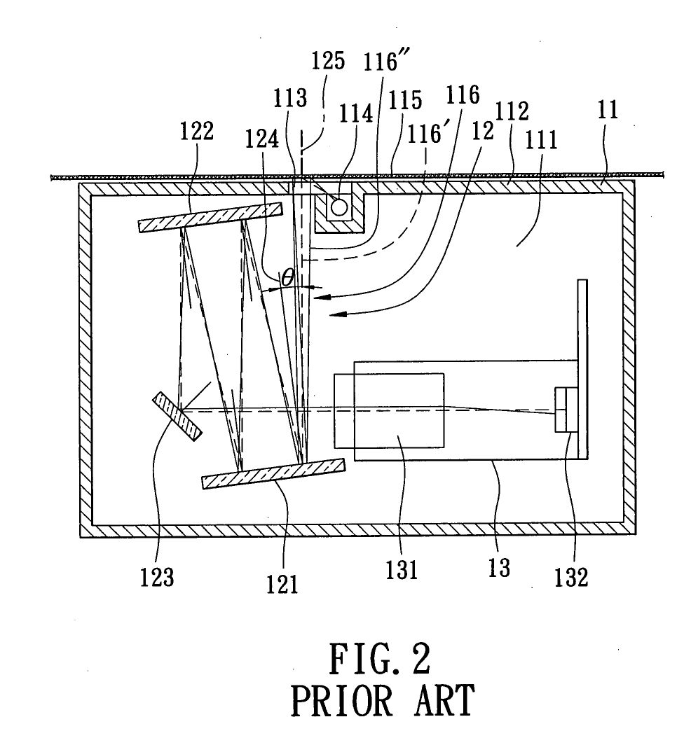

FIG. 3 is a schematic view of the first preferred embodiment of a scanning module according to this invention, illustrating the light path of an incident light field;

FIG. 4 is a view similar to FIG. 3, illustrating the light paths of accurate and inaccurate incident light beams withinn the light field in the first preferred embodiment;

FIG. 5 is s schematic view of the second preferred embodiment of a scanning module according to this invention, illustrating the light path of an incident light field; and

FIG. 6 is a view similar to FIG. 5, illustrating the light paths of accurate and inaccurate incident light beams within the light field in the second preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numbers throughout the entire disclosure.

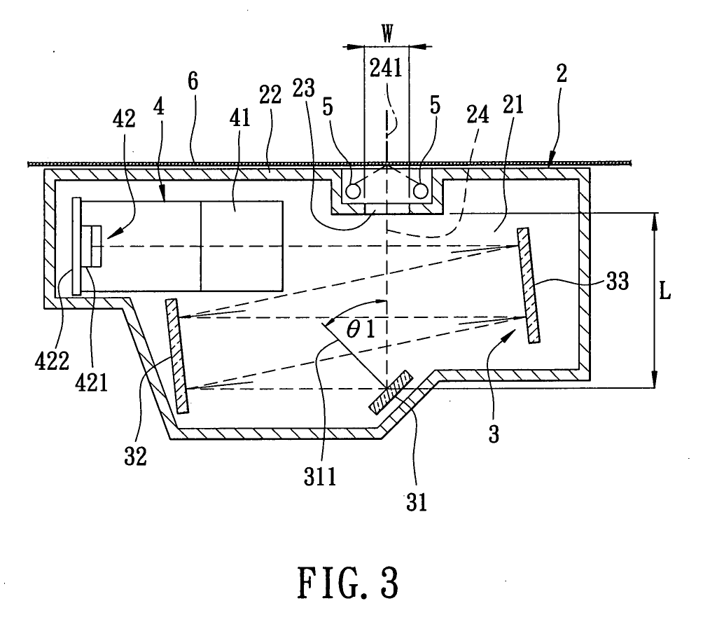

Reffering to FIG. 3, the first preferred embodiment of a scanning module according to this invention includes a body 2, a reflecting unit 3, and an image capture unit 4. The body 2 includes a surrounding wall 22 and a reflecting chanber 21 disposed in the surrounding wall 22. The surrounding wall 22 is formed with an incident hole 23. Two light-emitting units 5 are located respectively to two opposite sides of the incident hole 23. When light is emitted from the light-emitting units 5 onto a document 6 to be scanned, which is disposed above the incident hole 23, it is reflected into the reflecting chamber 21 through the incident hole 23 along an incident axis 241 so as to form an incident light field 24. The incident light field 24 is perpendicular to the document to be scanned. The incident hole 23 has a width (W) of 5 mm.

The reflecting unit 3 is disposed within the reflecting chamber 21, and includes a first reflector 31 for reflecting the incident light field 24, a second reflector 32 for reflecting light transmitted from the first reflector 31, and a third reflector 33 for reflecting light transmitted from the second reflector 32. The first, second, and third reflectors 31, 32, 33 are configured as reflecting mirrors. The first reflector 31 is disposed in a bottom end portion of the reflecting chamber 21. A preset angle θ1 formed between the incident axis 241 and a normal line 311 of the first reflector 31 is 45 degrees. A distance (L) traveled by the incident light field 24 from the incident hole 23 to the first reflector 31 is 20 mm. The second reflector 32 is adjacent to the image capture unit 4. The thirs reflector 33 is parallel to the second reflector 32.

The image capture unit 4 is disposed in the reflecting chamber 21 between the second reflector 32 and a top wall portion of the surrounding wall 22, and nearer to the incident hole 23 in the surrounding wall 22 of the body 2 than the first reflector 31 along a direction of the incident axis 241. Alternatively, the image capture unit 4. The third reflector 33 is parallel to the second reflector 32.

The image capture unit 4 is disposed in the reflecting chamber 21 between the second reflector 32 and a top wall portion of the surrounding wall 22, and nearer to the incident hole 23 in the surrounding wall 22 of the body 2 than the first reflector 31 alond a direction of the incident axis 241. Alternately, the image capture unit 4 is disposed outwardly of the body 2, and is connected to the body 2. The image capture unit 4 includes a lens 41 permitting light transmitted from the third reflec 33 to pass therethrough, and a sensing member 42 for converting the light passing through the lens 41 into a corresponding electrical signal. In this embodiment, the sensing member 42 includes a sensor 421 and a mounting plate 422. The sensor 421 includes a sensor 421 and a mounting plate 422. The sensor 421 may be a charge coupled device (CCD) image sensor or a complimentary oxide semiconductor (CMOS) image sensor.

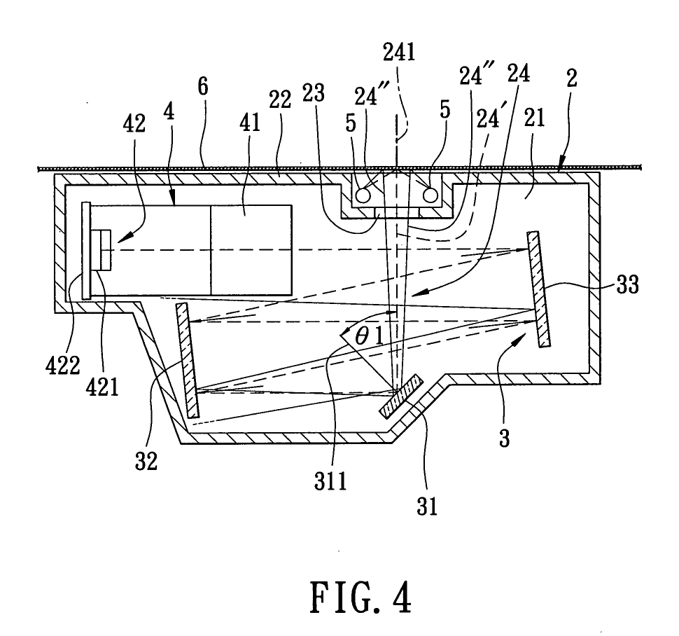

Referring to FIG. 4, the incident light field 24 includes at least one accurate incident light beam 24′ forming the preset angle θ1 with respect to the normal line 311, and at least two inaccurate incident light beams 24″ each forming an angle different fro the preset angle θ1 with respect to the normal line 311.

When the accurate light beam 24′ is incident on the first reflector 31, it is reflected from the first reflector 31 toward the second reflector 32 along a horizontal direction, subsequently, between the second and third reflectors 32, 33 three times, and is finally passed through the lens 41 of the image capture unit 4 along the horizontal direction. When each of the inaccurate light beams 24″ is incident on the first reflector 31, it is reflected 32 along a generally horizontal direction. In oother words, in the first preferred embodiment, any light beams reflected from the first reflector 31 cannot be transmitted back onto the document 6 to be scanned. Thereafter, the inaccurate light beam 24′ is reflected between the second and third reflectors 32, 33, and ultimately disappears as a result of failure to satisfy reflecting conditions or entering into a non-reflecting region.

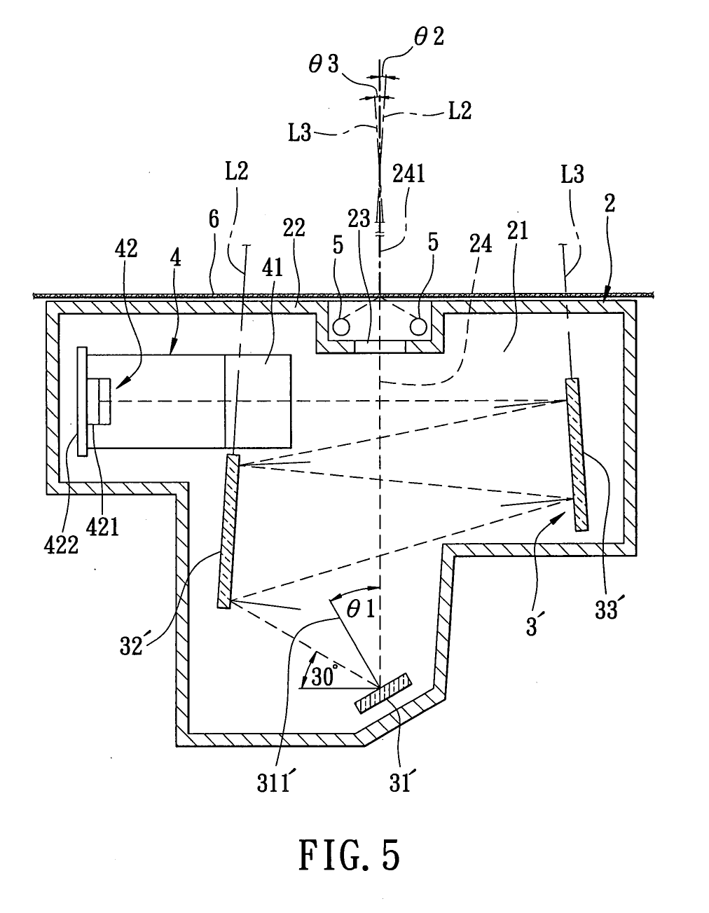

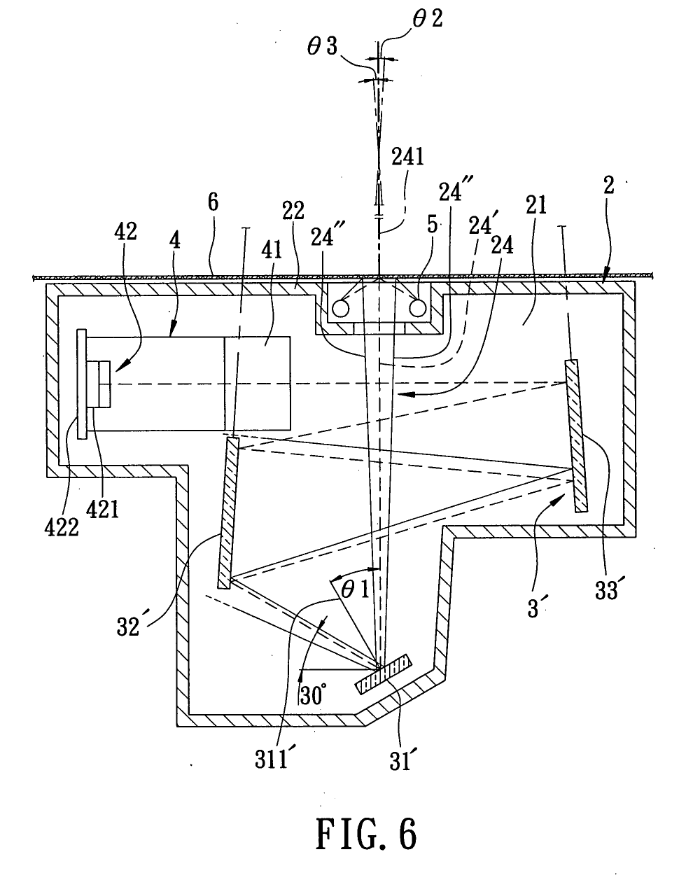

Referring to FIGS. 5 and 6, the second preferred embodiment of a scanning module according to this invention includes a modified reflecting unit 3′. The modified reflecting unit 3′ includes first, second, and third preferred embodiment, the second and third reflectors 32′, 33′ are not parallel to each other, the preset angle θ1 is 30 degress, the second reflector 32′ extends along an axis (L2) forming an angle θ2 of 3.75 degrees with respect to the incident axis 242, and the third reflector 33′ extends along an axis (L3) forming an angle θ3 of 3.75 degrees with respect to the incident axis 241. When the accurate incident light beam 24′ forming the preset angle θ1 with respect to the normal line 311′ is incident on the first reflector 31′, it is reflected toward the second reflector 32′ along a direction forming an angle of 30 degrees with respect to a horizontal line, subsequently, between the second and third reflectors 32′, 33′three times, and is finally passed through the lens 41 of the image capture unit 4 along a horizontal direction. When the inaccurate incident light beams 24″ are incident on the first reflector 31′, they cannot be reflected back onto the document to be scanned, as shown in FIG. 6. Thereafter, the inaccurate light beam 24′ is reflected between the second and third reflectors 32, 33 and ultimately disappears as a result of failure to satisfy reflecting conditions or entering into a non-reflecting region.

In view of the above, the scanning module of this invention is designed to form the preset angle θ1 between the incident axis 241 and a normal line 311 of the first reflector 31. The preset angles θ1 in the first and second preferred embodiment are 45 and 30 degrees, respectively. This prevents the inaccurate light beams 24′ from reflecting from the first reflector 31 onto the document 6 to be scanned. Thus, this invention can avoid effectively images formed from the inaccurate light beams 24′, which would affect adversely the scanning quality. As a result, the object of this invention is achieved.

With this invention thus explained, it is apparent that numerous modifications and variations can be made without departing from the scope and spirit of this invention. It is therefore intended that this invention be limited only as indicated by the appended claims.

We claim:

1. A scanning module comprising:
a body including a surrounding wall and a reflecting chamber disposed in said surrounding wall, said surrounding wall being formed with an incident hole adapted to allow an incident light field to transmit into said reflecting chamber through said incident hole along an incident axis;
a reflecting unit disposed within said reflecting chamber in said body and including a first reflector for reflecting said incident light field, a second reflector for reflecting light transmitted from said first reflector, and a third reflector for reflecting light transmitted from said second reflector, an angle formed between said incident axis and a normal line of said first reflector being not smaller than 30 degrees; and
an image capture unit being disposed nearer to said incident hole than said first reflector along a direction of said incident axis, said image capture unit including a lens permitting light transmitted from said third reflector to pass therethrough, and a sensing member for converting the light passing through said lens into a corresponding electric signal.

2. The scanning module as claimed in claim 1, wherein a distance traveled by said incident light field from said incident hole in said surrounding wall to said first reflector of said reflecting unit along said incident axis is not smaller than 20 mm.

3. The scanning module as claimed in claim 2, wherein said incident hole in said surrounding wall of said body has a width that is not smaller than 5 mm.

4. The scanning module as claimed in claim 1, wherein an angle formed between said normal line of said first reflector and said incident axis is 45 degrees.

5. The scanning module as claimed in claim 4, wherein said second and third reflectors of said reflecting unit are disposed parallel to each other.

6. The scanning module as claimed in claim 1, wherein said image capture unit is disposed in said reflecting chamber in said body.
